(19) United States
(12) Patent Application Publication
(10) Pub. No.: US 2011/0259975 A1
(43) Pub. Date: Oct. 27, 2011

(54) Nozzle assembly for sprinkler

(75) Inventor: Shun-Nan Lo, Taichung (TW)

(73) Assignee: YUAN-MEI CORP.

(21) Appl. No.: 12/662,579

(22) Filed: Apr. 23, 2010

(51) Int. Cl. B05B 1/08

(52) U.S. Cl. 239/99

(57) ABSTRACT

A nozzle assembly for a sprinkler is revealed. The nozzle assembly includes a main channel having a water inlet on one end and a water outlet on the other end thereof The nozzle assembly features on that: an adjustment member for control of water flow is disposed on the main channel, located between the water inlet and the water outlet. The adjustment member is arranged around the main channel. The displacement direction of the adjustment member and the water flow direction of the main channel are not along the same axis, or not parallel to each other. Thus when the nozzle assembly is applied to underground sprinklers; it is hidden from view and is able to prevent others from changing outlet water flow purposely.

### BACKGROUND OF THE INVENTION

1. Fields of the Invention

The present invention relates to a nozzle assembly for a sprinkler, especially to a nozzle assembly for a sprinkler that can provide on-off control of water and regulate the amount of water output.

2. Descriptions of Related Art

A nozzle assembly for conventional underground sprinklers is revealed. Refer to U.S. Pat. No. 5,086,977 “SPRINKLER DEVICE”, underground sprinklers in which water pressure causes a pop-up riser means being moved to its extend or retracted position are disclosed. A nozzle assembly is mounted in an axially movable nozzle housing assembly that is received in a cylindrical housing. An opening is formed in the outer surface of the nozzle housing and a nozzle is inserted through the opening into the nozzle housing assembly. The top of a cylindrical member of the riser means has an adjusting slot for setting the desired oscillating angle for the sprinkler. After water flowing through, the nozzle assembly is popped up slowly to a preset position and then water is ejected from the nozzle.

The amount of water output though the above nozzle assembly is unable to be adjusted. Thus the water flow ejected out from the nozzle assembly is delivered to a certain range. The water flow is unable to be modified according to terrain and users' requirements.

A nozzle assembly with adjustable water output has been developed and invented based on the structure of the above underground sprinklers. Refer to U.S. Pat. No. 6,241,158 “Irrigation sprinkler with pivoting throttle valve” and U.S. Pat. No. 6,050,502 “Rotary sprinkler with memory arc mechanism and throttling valve”, a pivotable arc valve body is arranged on a vertical water channel, located in a riser just below the nozzle. The arc valve is pivotable between two positions by manually turning a drive member with a hand tool. When the valve body pivots to its first (vertical) position, the water flow path is substantially open while the valve body substantially obstructs the water flow path when it pivots to a second (horizontal) position.

Although the above nozzle assemblies provide functions of on-off and water flow adjustment, they still have following shortcomings:

1. The arc valve body of the nozzle assembly is set and pivoted in the vertical water channel. The space inside the vertical water channel is small and narrow and this causes difficulties in assembling the arc valve body.
2. Through a gear drive assembly operated by a hand tool, the nozzle is rotated by the arc valve body in above two patents. Thereby the operation of the drive assembly is not smooth once the connection between the drive member and the arc valve body is poor. On the other hand, once the connection therebetween is good, the arc valve body is difficult to be located precisely. When the arc valve body is in the closed position, it is easy to be moved due to flow pressure and the water flow path is opened automatically.
3. The drive member is mounted in the upper end of the nozzle assembly and is parallel to the vertical water channel of the nozzle assembly. Thus the top of a driving end of the drive member is exposed on a top surface of the nozzle assembly for convenience of moving and adjusting the drive member. However, everyone can easily change the water flow if he intends and there is no protection design.

Thus there is a space to improve the nozzle assembly available now and a need to provide the nozzle assembly with novel design.

### SUMMARY OF THE INVENTION

Therefore it is a primary object of the present invention to provide a sprinkler nozzle that is able to regulate the outlet water flow.

In order to achieve the above object, a nozzle assembly for a sprinkler according to the present invention is disposed on a top of an inner tube of a sprinkler. A vertical main channel is arranged along an axis of the nozzle assembly. A water inlet connected with a water source for water supply is arranged at the bottom of the main channel while a water outlet is set on one side of the other end of the main channel. An adjustment member for control of water flow is disposed on the main channel, located between the water inlet and the water outlet. A side hole set on the main channel is connected with a ring while an inner threaded section is arranged near an outer end of an inner bore of the ring. The adjustment member is a cylinder in which one end is a conical frustum having maximum outside diameter larger than the outside diameter of the cylinder and the other end is a slot. The conical frustum is for closing the water outlet while the slot is used to assemble with driving devices. An outer threaded section and a ring groove are respectively arranged on a surface of one end of the adjustment member having the slot. The outer threaded section is threaded with the inner threaded section of the ring while the ring groove is for receiving a sealing ring whose outer part is closely attached to the inner bore of the ring.

In accordance with the above structure and parts, the diameter of a flow path opened from the main channel to the water outlet is controlled by the displacement of the adjustment member so as to regulate output water flow.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive cross-sectional view of an embodiment according to the present invention;

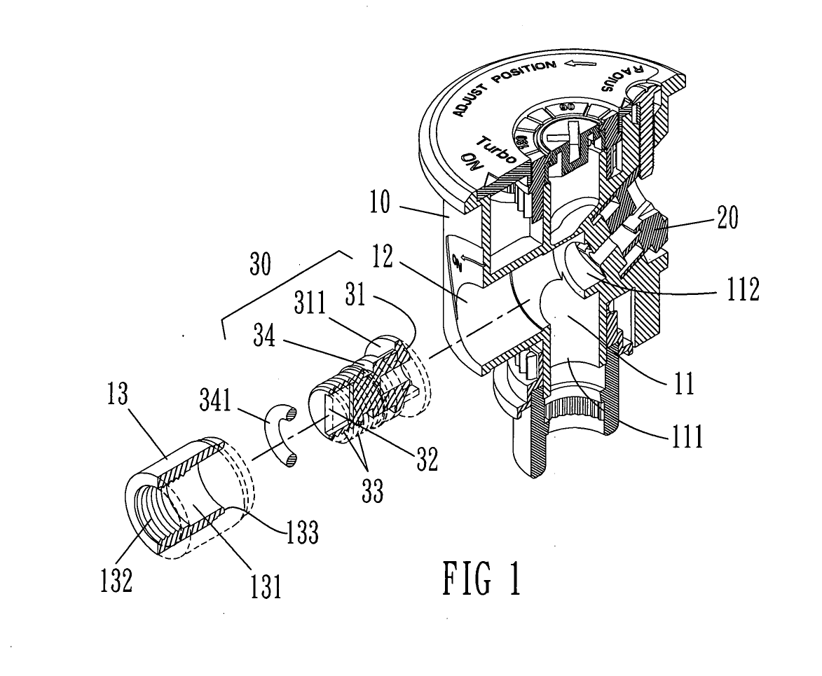

FIG. 2 is assembled cross sectional view of an embodiment according to the present invention;

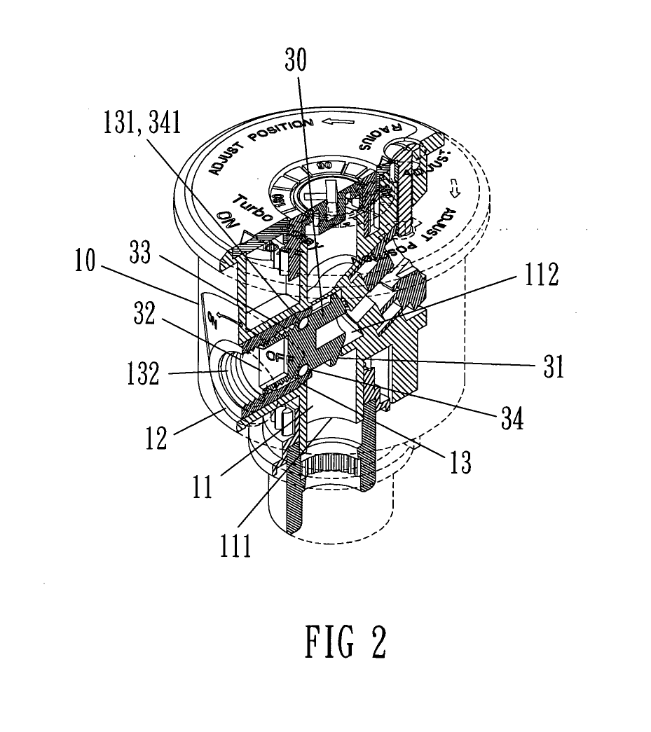

FIG. 3 is a perspective view of an embodiment according to the present invention;

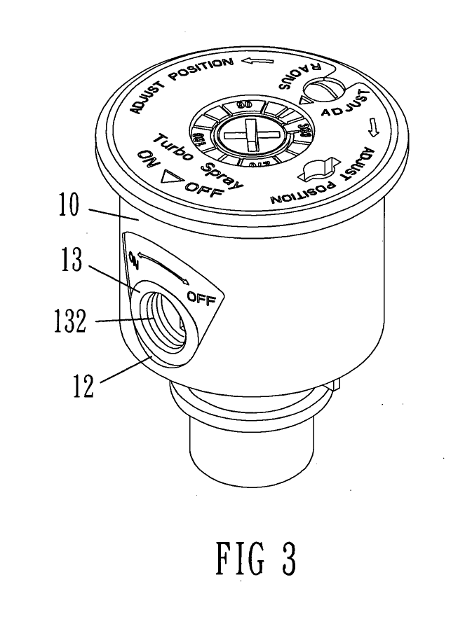

FIG. 4 is a side cross sectional view of an embodiment according to the present invention;

FIG. 5 is a schematic drawing showing action of the embodiment in FIG. 4;

FIG. 6 is a schematic drawing showing an embodiment of the present invention assembled to a sprinkler;

FIG. 7 is another schematic drawing showing an embodiment of the present invention assembled to a sprinkler;

FIG. 8 is side cross sectional view of another embodiment according to the present invention;

FIG. 9 is an explosive view of a further embodiment according to the present invention;

FIG. 10 is an assembled view of the embodiment in FIG. 9;

FIG. 11 is an assembled cross sectional view of the embodiment in FIG. 9.

### DETAILED DESCRIPTION OF THE PREFERRED EMBODIMENT

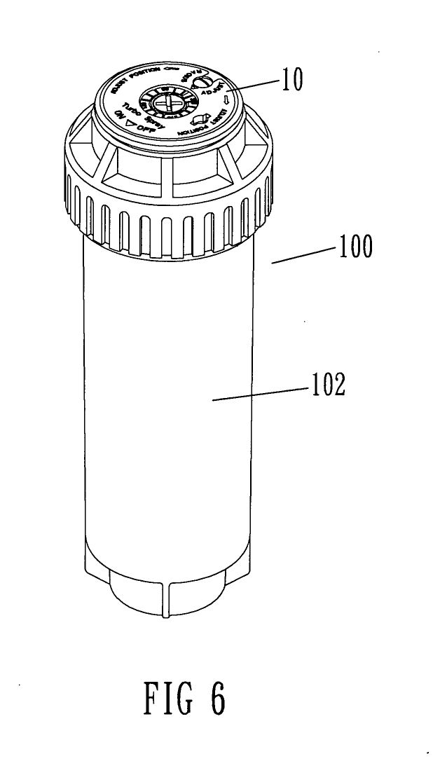

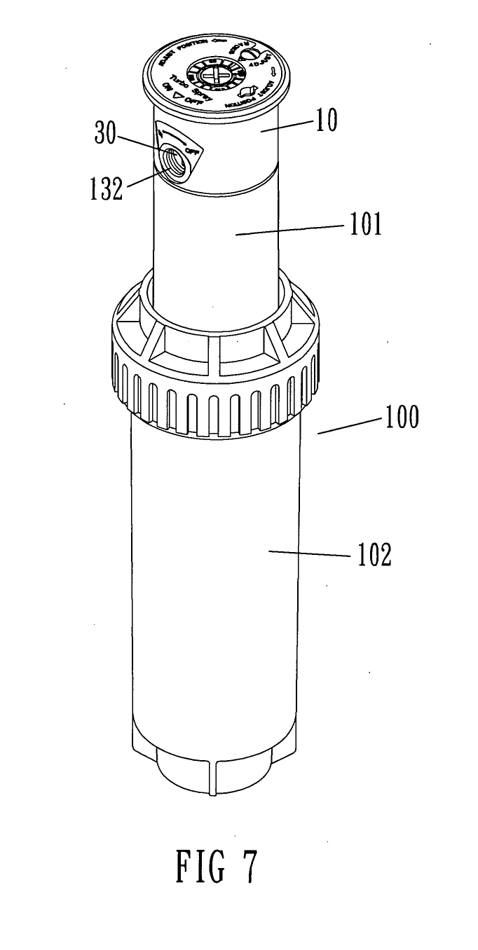

Refer to FIG. 7, a nozzle assembly 10 for a sprinkler is connected on a top of an inner tube 101 of a sprinkler 100 shown in FIG. 6 and FIG. 7. The above mentioned inner tube 101 is mounted in an outer tube 102 of the sprinkler 100. The inner tube 101 is moved up and down automatically by water pressure. After water being turned off, the inner tube 101 is retracted into the outer tube 102. A water outlet 112 arranged at one side of the nozzle assembly 10 on top of the inner tube 101 is also hidden inside the outer tube 102, not exposed. The connection between the sprinkler 100 and the nozzle assembly 10 is similar to that in prior arts.

The nozzle assembly 10 of the present invention features on that: a vertical main channel 11 is disposed along an axis of the nozzle assembly 10. A water inlet 111 connected with a water source for water supply is arranged at the bottom of the main channel 11 while the water outlet 112 is disposed on one side of the other end of the main channel 11. A nozzle 20 is disposed on a front end of the water outlet 112. An adjustment member 30 that controls water flow is arranged at the main channel 11, between the water inlet 111 and the water outlet 112. The water outlet 112 is closed or opened by displacement of the adjustment member 30. The flow path diameter opened is also controlled by the adjustment member 30.

In this embodiment, the connection between the nozzle assembly 10 and the adjustment member 30 is as following. A side hole 12 is disposed on the main channel 11 of the nozzle assembly 10 and is connected with a ring 13. An inner threaded section 132 is set near an outer end of an inner bore 131 of the ring 13. The ring 13 is integrated with the side hole 12 by high frequency induction heating.

The adjustment member 30 is a cylinder in which one end is a conical frustum 31 whose maximum outside diameter is larger than the outside diameter of the cylinder while the other end is a slot 32. The conical frustum 31 is used to close the water outlet 112 while the slot 32 is for mounting driving devices (not shown in figure). An outer threaded section 33 and a ring groove 34 are respectively arranged around the surface of one end of the adjustment member 30 with the slot 32. The outer threaded section 33 is threaded with the inner threaded section 132 of the ring 13. A sealing ring 341 is mounted in the ring groove 34 and an outer part of the sealing ring 341 is closely attached to the inner bore 131 of the ring 13.

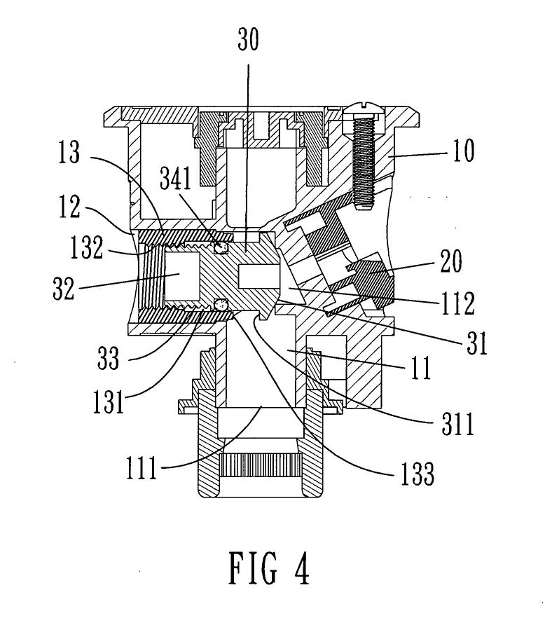

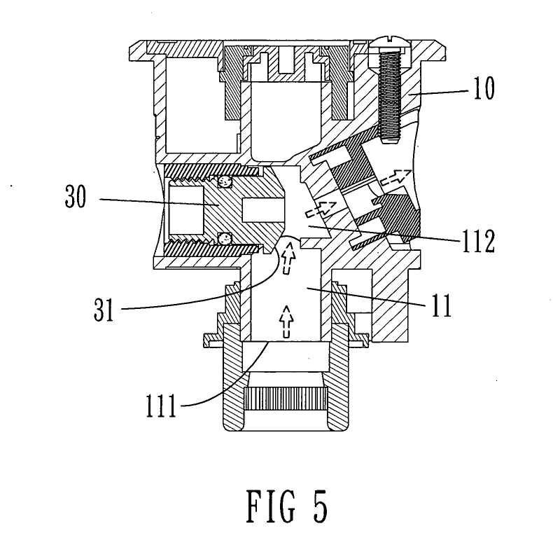

According to the structure formed by above components, as shown in FIG. 4 and FIG. 5, while rotating the adjustment member 30, it is driven to move horizontally. Thereby the conical frustum 31 of the adjustment member 30 is also moved to open or close the water outlet 112. Moreover, the diameter of the path from the main channel 11 to the water outlet 112 is controlled by the adjustment member 30 so as to regulate output water flow.

The ring 13 is connected to the side hole 12 on the main channel 11 of the nozzle assembly 10. Then the adjustment member 30 is threaded into the ring 13 and the conical frustum 31 whose maximum outside diameter is larger than the outside diameter of the adjustment member 30 is arranged at one end of the adjustment member 30. Thus a side end surface 311 of the conical frustum 31 beside the adjustment member 30 is against an inside end surface 133 of the ring 13 correspondingly. Thereby the adjustment member 30 will not be released from the ring 13 during the displacement process.

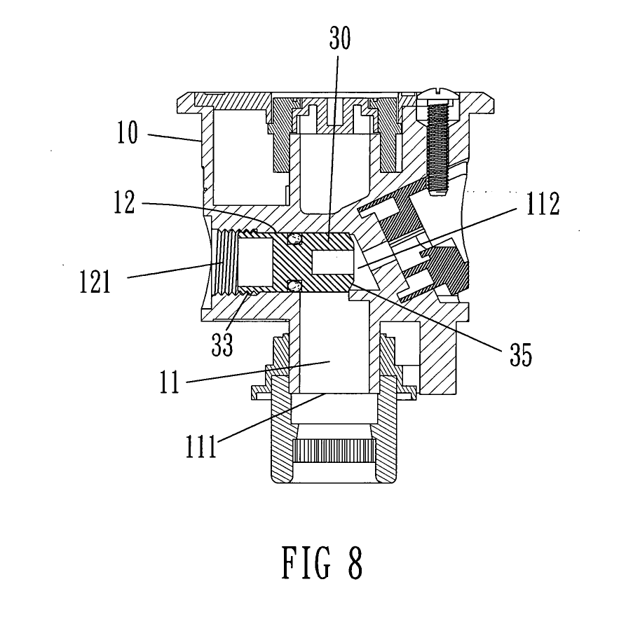

As shown in FIG. 8, another embodiment of the present invention is revealed. An inner threaded hole 121 is disposed near an outer end of the side hole 12. Thus the adjustment member 30 with the outer threaded section 33 can be threaded with the inner threaded hole 121 directly. Moreover, a curved surface 35 is arranged at one end of the adjustment member 30 that faces the water outlet 112 for closing the water outlet 112. Thereby the output water flow can also be adjusted and controlled.

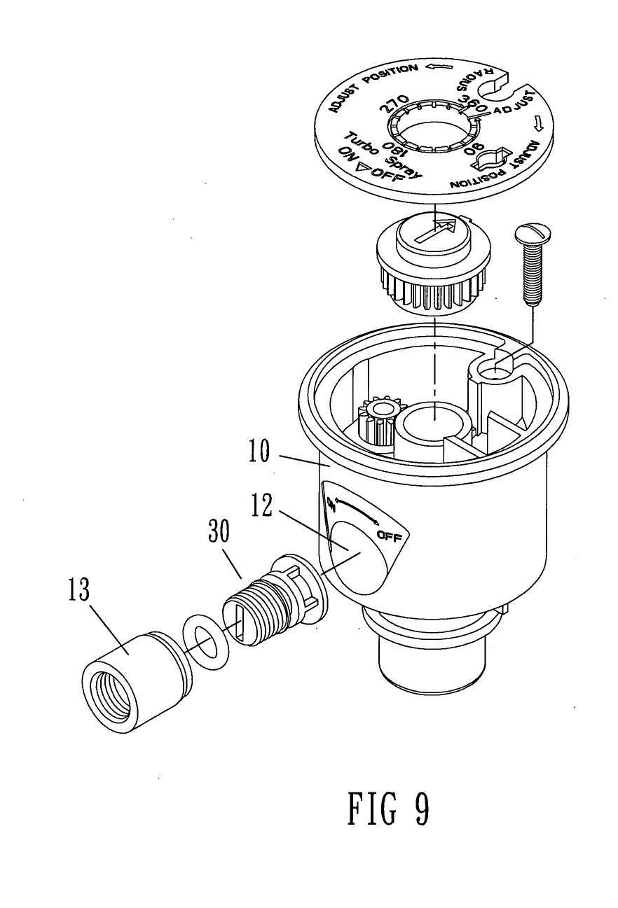

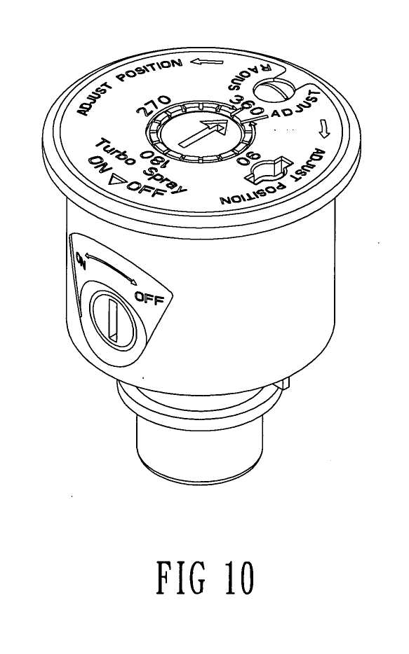

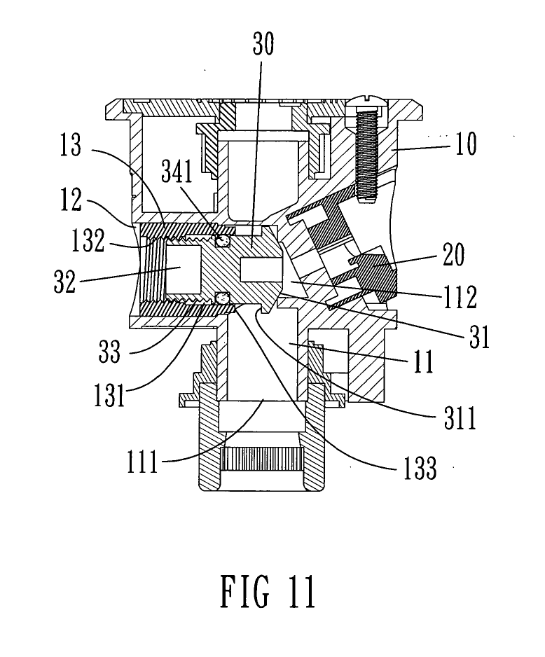

Furthermore, refer from FIG. 9 to FIG. 11, a further embodiment is disclosed. The difference between this embodiment and above two is in that: the structure of the nozzle assembly 10 that is assembled with the adjustment member 30. That means differences in designs of parts for connection in an upper open end of the nozzle assembly 10.

In summary, the direction of displacement of the adjustment member and the direction of the water flow in the main channel of the nozzle assembly are crossed. In this embodiment, the directions are perpendicular to each other. Or there is a certain angle between the two directions. The adjustment member is connected and assembled around the nozzle assembly. Thereby after the nozzle assembly being hidden in the outer tube of the sprinkler, the outlet water flow is unable to be changed by others purposely.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A nozzle assembly for a sprinkler comprising: a nozzle assembly disposed with a main channel;
the main channel having a water inlet on one end thereof and a water outlet on the other end thereof;
wherein an adjustment member that closes the water outlet and controls diameter of a flow path opened from the main channel to the water outlet is connected with the main channel.

2. The device as claimed in claim 1, wherein a side hole is disposed on the main channel of the nozzle assembly and is connected with a ring having an inner threaded section; a conical frustum for closing the water outlet is arranged at one end of the adjustment member while an outer threaded section for being threaded with the inner threaded section of the ring is disposed on the other end of the adjustment member.

3. The device as claimed in claim 2, wherein a slot for being rotated and driven is disposed on an outer end of the adjustment member, opposite to the end of the adjustment member with the conical frustum.

4. The device as claimed in claim 1, wherein a side hole having an inner threaded section is disposed on the main channel of the nozzle assembly; a curved surface for closing the water outlet is arranged at one end of the adjustment member while an outer threaded section for being threaded with the inner threaded section is disposed on the other end of the adjustment member.

5. The device as claimed in claim 1, wherein a direction of displacement of the adjustment member and a direction of a vertical water flow in the main channel of the nozzle assembly are crossed.

6. A nozzle assembly for a sprinkler comprising:
a nozzle assembly disposed with a main channel;
the main channel having a water outlet on one end thereof;
wherein an adjustment member is mounted in the main channel by a threaded joint; the adjustment member is rotated to be driven to move forward or backward so as to make a conical frustum on one end of the adjustment member close the water outlet or change water flow from the water outlet.

7. A nozzle assembly for a sprinkler comprising:
a nozzle assembly disposed with a main channel;
the main channel having a water outlet on one end thereof;
wherein the main channel is horizontally threaded with an adjustment member;
the adjustment member is able to be moved and adjusted directly so that one end of the adjustment member is driven to close the water outlet directly or change a flow path diameter for control of water flow from the water outlet.
